(19) United States
(12) Patent Application Publication
(10) Pub. No.: US 2012/0301618 A1
(43) Pub. Date: Nov. 29, 2012

(54) GOLF BALLS INCORPORATING CERIUM OXIDE NANOPARTICLES

(76) Inventors: Shawn Ricci, New Bedford, MA (US); Randy Petrichko, Richmond, RI (US)

(21) Appl. No.: 13/117,400

(22) Filed: May 27, 2011

Related U.S. Application Data
(63) Continuation of application No. 13/117,366, filed on May 27, 2011.
Application No. 13/117,366 is a continuation of application No. 13/117,228, filed on May 27, 2011.

(51) Int. Cl. B05D 3/12

(52) U.S. Cl. 427/331

(57) ABSTRACT

The invention is directed to a golf ball providing improved UV resistance, abrasion resistance and hydrophobicity comprising cerium oxide nanoparticles having a particle size within the wavelength of visible light. The golf ball of the invention may comprise the cerium oxide nanoparticles in any or all of outer core layers, intermediate layers, inner cover layers, outer cover layers and even as a coating composition in an amount of from about 0.5 wt % to about 10 wt % of the respective layer. The cerium oxide nanoparticles may be randomly dispersed within a layer or coating, or alternatively, the cerium oxide nanoparticles may be ordered in an array within the layer or coating.

### CROSS-REFERENCE TO RELATED APPLICATIONS

This application is a continuation of co-pending U.S. patent application Ser. No. 13/117,366, filed May 27, 2011, which is a continuation of co-pending U.S. patent application Ser. No. 13/117,228, filed May 27, 2011.

### FIELD OF THE INVENTION

Golf balls incorporating materials which improve UV resistance, abrasion resistance and hydrophobicity.

### BACKGROUND OF THE INVENTION

Golf balls are generally divided into two classes: solid and wound. Solid golf balls include a solid core of one or more layers, a cover of one or more layers, and optionally one or more intermediate layers. Wound golf balls typically include a solid, hollow, or fluid-filled center, surrounded by tensioned elastomeric material, and a cover. Solid golf balls, as compared with wound balls, are more durable and resilient, providing better distance than wound balls due to their higher initial velocity upon impact with a club face. Meanwhile, the wound construction provides a softer “feel”, lower compression and higher spin rate—characteristics often preferred by accomplished golfers who are able to control the ball's flight and positioning.

Notwithstanding a golf ball's particular construction, it is important that the golf ball appear and remain aesthetically pleasing to golfers. In this regard, preserving a white pigmented golf ball's color conveys high product quality and reliability over a white golf ball which yellows or browns over time from exposure to light, in particular, ultraviolet (UV) light. Yellowing is a common problem in golf ball covers made of thermoset or thermoplastic polyurethanes or polyureas due to the presence of an aromatic component in each—e.g., aromatic diisocyanate, polyol, or polyamine.

Previously, manufacturers have addressed golf ball cover yellowing by incorporating UV blockers, absorbers or light stabilizers in the cover and even by modifying the polyurethanes or polyureas themselves. In one approach, manufacturers disclose surface-treating TiO₂ with oxides, such as CeO₂, before adding the TiO₂ into a cover formulation in order to suppress photocatalytic action, which is inherent to aluminum oxide. See U.S. Pat. No. 7,207,904 of Isogawa et al. (“the '904 patent”). Under UV illumination, absorption of a photon with a higher energy than the bond gap creates an electron-hole pair in both TiO₂ and CeO₂. But since TiO₂ has less localized electrons (3 d orbital) than CeO₂ (4 f orbital), TiO₂ electron-hole pairs migrate to the surface of TiO₂ particles rather than recombining together inside the particle. Then, when electrons and holes migrate to the surface, they react with oxygen, water or hydroxyls to form free radicals which cause polymeric degradation, resulting in yellowing of an otherwise white cover surface. In the '904 patent, the degradation associated with a TiO₂ is reduced by either forming a layer containing cerium oxide around each titanium oxide particle or adhering fine particles containing cerium oxide on the surface of the titanium oxide. See the '904 patent, e.g., at col. 3, lines 40-53, FIG. 1 and FIG. 2.

Golf ball manufacturers have also incorporated cerium oxide nanoparticles having particle sizes of from about 1 nm to about 50 nm (0.001μ-0.05 μ) in cover “color traveling” coating formulations to increase the difference in refractive index between a polymer matrix and particles added to the matrix when the difference is not great enough to achieve the desired effect of perceived varying color. See e.g. U.S. Pat. No. 7,220,192 of Andre et al. at col. 6, lines 20-29. Particle sizes of 1 nm to about 50 nm (0.001μ to about 0.05 μ), being less than the wavelength of visible light (about 370 nm to about 800 nm (about 0.37μ-about 0.80μ)), do not substantially reflect or scatter light. Id. at co. 6, lines 27-29.

However, it would be advantageous if a cerium oxide particle sizes could be identified which preserve the whiteness of a golf ball cover independently and irrespective of the presence/absence or positioning of titanium oxide particles or any other pigment or colorant in the composition.

Meanwhile, durability—that is, a scuff and/or abrasion resistance—remains a further concern which directly affects the aesthetics of the golf ball. A scuff and/or abrasion resistant cover presents the player with apparently high quality and attractive golf ball. Golf ball manufacturers have found it challenging to address this aesthetic aspect without compromising the “soft feel” desired by players. There remains a need for golf ball cover composed of or coated with versatile materials which not only reduce yellowing but simultaneously improve scuff/abrasion resistance, without substantially impacting the soft feel.

Meanwhile, it is desirably cost effective for golf ball manufacturers to find solutions to “aesthetics” related golf ball issues which also address and resolve “performance” related issues such as moisture penetration into the golf ball. Moisture penetration issues typically arise, for example, when golf ball manufacturers use polybutadiene cores cross-linked with peroxide and/or zinc diacrylate in the golf ball core. The core is the “engine” of the golf ball when hit with a club head—that is, the spring of the ball and its principal source of resiliency. Water moisture vapor reduces the resiliency of the core and degrades its properties. Thus, preferably a golf ball core is covered quickly to maintain and preserve optimum golf ball properties.

Intermediate layers of the golf ball based on ionomers aid in maintaining initial speed, contribute to desired spin rate, and improve playability/impact durability as well as acting as a moisture barrier to protect the cores from the COR loss. The cover typically protects the core from repeated impacts from golf clubs, but may also act as a moisture barrier or be coated to serve as one. The cover may be made from ionomer resins, balata, and urethane, among other materials. The ionomer covers, particularly the harder ionomers, offer some protection against penetration of water vapor. However, it is more difficult to control or impart spin to balls with hard covers. Conventional urethane covers, on the other hand, while providing better ball control due to increased spin, offer less resistance to water vapor than ionomer covers.

The golf ball may also comprise additional layers, such as an outer core layer or an inner cover layer—often to increase the resiliency of the ball but also may serve to protect the core or inner core from moisture infiltration.

Prolonged exposure to high humidity and elevated temperature may be sufficient to allow water vapor to invade and permeate the cores of some commercially available golf balls. For example at 110° F. and 90% humidity for a sixty day period, significant amounts of moisture enter the cores and reduce the initial velocity of the balls by 1.8 ft/s to 4.0 ft/s or greater. The absorbed water vapor will decrease core compression by about 5 to about 10 units and also reduce the coefficient of restitution (COR) of the ball.

Commonly owned U.S. Pat. No. 6,632,147 B2 broadly suggests incorporating “nanoparticles” in barrier layers for increasing the layer's resistance to the transmission of moisture through the layer. Still, there is a need to identify specific hydrophobic nanoparticle-containing materials which serve as particularly protective encasing layers (outer core, intermediate, inner cover, outer cover) and/or coatings which impart improved moisture penetration resistance to the molded layer thereby preserving, maintaining and/or enhancing optimum golf ball properties and desired golf ball characteristics such as spin, resilience and durability.

To date, manufacturers have found it difficult to simultaneously improve/preserve aesthetic qualities and address issues affecting player performance. Accordingly, a golf ball having a cover incorporating a versatile material which simultaneously provides the advantages of UV resistance, abrasion/scuff resistance and hydrophobicity would be useful as reducing manufacturing costs since that material could be included in a wide range of golf ball applications in any or all of outer core layers, intermediate layers, inner cover layers, outer cover layers and as a coating composition.

### SUMMARY OF THE INVENTION

The golf balls of the invention address and resolve all of the concerns identified above providing improved UV resistance (i.e., reduced yellowing), as well as better abrasion resistance and hydrophobicity. The invention is directed to a golf ball comprising cerium oxide nanoparticles having a particle size within the wavelength of visible light. The golf ball of the invention may comprise the cerium oxide nanoparticles in any or all of outer core layers, inteimediate layers, inner cover layers, outer cover layers and even as a coating composition. One or more of these golf ball components may comprise a thermoset or thermoplastic composition comprising the cerium oxide nanoparticles. Alternatively, the thermoset or thermoplastic composition may comprise a cerium oxide composition consisting essentially of cerium oxide nanoparticles having a particle size within the wavelength of visible light.

Also, the cerium oxide composition may consist of cerium oxide nanoparticles having a particle size within the wavelength of visible light.

The wavelength of visible light, as defined herein, may be from about 370 nm to about 800 nm, or from about 370 nm to about 750 nm, or from about 400 nm to about 800 nm, or from about 400 nm to about 750 nm, or from about 380 nm to about 750 nm, or from about 400 nm to about 700 nm, or from about 625 nm to about 740, or from about 590 nm to about 625 nm, or from about 565 nm to about 590 nm, or from about 520 nm to about 565 nm, or from about 500 nm to about 520, or from about 435 to about 500 nm, or from about 380 nm to about 435 nm. Accordingly, the cerium oxide nanoparticles may have a particle size within any of these wavelength ranges.

In one embodiment, the golf ball comprises a core layer, a cover layer and optionally an intermediate layer disposed between the core and the cover, wherein the cover layer comprises a thermoset or theromoplastic composition comprising a substantially homogeneous particulate consisting of cerium oxide nanoparticles having a particle size of from about 370 nm to about 800 nm

In another embodiment, the cover layer comprises a thermoset or theromoplastic composition comprising cerium oxide nanoparticles having a particle size of from about 370 nm to about 800 nm, wherein the cerium oxide nanoparticles are randomly dispersed within the thermoset or theromoplastic composition. In another embodiment, the cover layer comprises cerium oxide nanoparticles which are randomly dispersed within the thermoset or theromoplastic composition independently of titanium oxide and/or a plurality of titanium oxide particles distributed within the thermoset or theromoplastic composition. In yet another embodiment, the cerium oxide nanoparticles are randomly dispersed within the thermoset or theromoplastic composition independently of a pigment distributed within the thermoset or theromoplastic composition.

In still another embodiment, the cover layer comprises a thermoset or theromoplastic composition comprising cerium oxide nanoparticles having a particle size of from about 370 nm to about 770 nm, wherein the cerium oxide nanoparticles are ordered in an array within the thermoset or theromoplastic composition. Alternatively, the cover layer comprises a thermoset or theromoplastic composition comprising cerium oxide nanoparticles having a particle size of from about 370 nm to about 800 nm, wherein the cerium oxide nanoparticles are ordered in an array within the thermoset or theromoplastic composition independently of a plurality of titanium oxide particles distributed within the thermoset or theromoplastic composition. Also, the cerium oxide nanoparticles are ordered in an array within the thermoset or theromoplastic composition independently of a plurality of a pigment distributed within the thermoset or theromoplastic composition.

In another aspect of the invention, golf ball comprises a core layer, a cover layer and optionally an intermediate layer disposed between the core and the cover, wherein the cover layer comprises a thermoset or theromoplastic composition comprising a prepolymer, a curing agent, a white pigment, and from about 1 wt % to about 4 wt % of a substantially homogeneous particulate consisting of cerium oxide nanoparticles having a particle size of from about 370 nm to about 800 nm, said substantially homogeneous particulate being randomly dispersed within the thermoset or theromoplastic composition.

The cover layer may alternatively be formed from a thermoset or theromoplastic composition comprising : (1) a prepolymer mixture comprising a substantially homogenous particulate consisting of titanium oxide; (2) a curing agent; and (3) from about 1 wt % to about 4 wt % of a substantially homogeneous particulate consisting of cerium oxide nanoparticles having a particle size of from about 370 nm to about 800 nm.

Instead, the cover layer is formed from a thermoset or theromoplastic composition comprising : (1) a prepolymer; (2) a curing agent comprising a substantially homogenous particulate consisting of titanium oxide; and (3) from about 1 wt % to about 4 wt % of a substantially homogeneous particulate consisting of cerium oxide nanoparticles having a particle size of from about 370 nm to about 770 nm.

In another embodiment,the cover layer comprises a thermoset or theromoplastic composition comprising a prepolymer; a curing agent, a substantially homogenous particulate consisting essentially of titanium oxide; and from about 1 wt % to about 4 wt % of a substantially homogeneous particulate consisting essentially of cerium oxide nanoparticles having a particle size of from about 370 nm to about 770 nm.

In yet another embodiment, the cover layer comprises a thermoset or theromoplastic composition comprising a white pigmented prepolymer, a curing agent, and from about 1 wt % to about 4 wt % of a substantially homogeneous particulate consisting of cerium oxide nanoparticles having a particle size of from about 370 nm to about 770 nm.

Also, the cover layer may comprise a thermoset or theromoplastic composition comprising a prepolymer, a white pigmented curing agent, and from about 1 wt % to about 4 wt % of a substantially homogeneous particulate consisting of cerium oxide nanoparticles having a particle size of from about 370 nm to about 770 nm.

Further, the golf ball may comprise a core and a cover disposed about the core wherein the cover comprises an inner surface and an outer surface, said outer surface being treated with and comprising a light stabilizing composition comprising cerium oxide nanoparticles having a particle size of from about 370 nm to about 770 nm.

The light stability of a cover may be quantified by the difference in yellowness index ΔYI, that is, yellowness measured after a predetermined exposure time minus yellowness before exposure. In one embodiment, the ΔYI for the cover of the golf ball of the invention is less than about 12.0 after 5 days. In another embodiment, the ΔYI for the cover of the golf ball of the invention is less than about 11.0 after 5 days. In yet another embodiment, the ΔYI for the cover of the golf ball of the invention is about 10.5 or less after 5 days. In still another embodiment, the ΔYI for the cover of the golf ball of the invention is about less than about 10 after 5 days.

In one embodiment, the ΔYI for the cover of the golf ball of the invention is less than about 15.0 after 8 days. The ΔYI for the cover of the golf ball of the invention is less than about 13.5 after 8 days. In another embodiment, the ΔYI for the cover of the golf ball of the invention is about 12.5 or less after 8 days. In yet another embodiment, the ΔYI for the cover of the golf ball of the invention is about 12.0 or less after 8 days.

Meanwhile, the difference in the b chroma dimension Δb*, yellow to blue, is also a way to quantify the light stability of a cover. In one embodiment, the Δb* for the cover of the golf ball of the invention is less than about 8 after 5 days. In another embodiment, the Δb* for the cover of the golf ball of the invention is about 6.75 or less after 5 days. In yet another embodiment, the Δb* for the cover of the golf ball of the invention is about 6.5 or less after 5 days. In still another embodiment, the Δb* for the cover of the golf ball of the invention is about 6.25 or less after 5 days or even 6.0 or less after 5 days.

The Δb* for the cover of the golf ball of the invention is about 9.5 or less after 8 days. In another embodiment, the Δb* for the cover of the golf ball of the invention is less than about 8.0 after 8 days. In yet another embodiment, the Δb* for the cover of the golf ball of the invention is about 7.75 or less after 8 days. In still another embodiment, the Δb* for the cover of the golf ball of the invention is about 7.25 or less after 8 days or even about 7.0 or less after 8 days.

For example, in one embodiment, ΔYI for the cover is less than about 11.5 after 5 days; ΔYI for the cover is less than about 13.5 after 8 days; Δb* for the cover is less than about 7.5 after 5 days; and Δb* for the cover is about 8.5 or less after 8 days. In another embodiment, ΔYI for the cover is less than about 11.0 after 5 days; ΔYI for the cover is about 13.0 or less after 8 days; Δb* for the cover is about 6.75 or less after 5 days; and Δb* for the cover is about 7.75 or less after 8 days. In yet another embodiment, ΔYI for the cover is about 10.9 or less after 5 days; ΔYI for the cover is about 12.6 or less after 8 days; Δb* for the cover is about 6.60 or less after 5 days; and Δb* for the cover is about 7.54 or less after 8 days. In still another embodiment, ΔYI for the cover is less than about 14.0 after 5 days; ΔYI for the cover is about 17.0 or less after 8 days; Δb* for the cover is about 8.0 or less after 5 days; and Δb* for the cover is about 9.5 or less after 8 days.

The golf ball of the invention may further comprise a core layer, a cover layer and optionally an inteimediate layer disposed between the core and the cover, wherein at least one of the core, the intermediate layer and the cover layer is formed from a composition comprising a substantially homogenous cerium oxide particulate consisting of nanoparticles having a particle size of from about 370 nm to about 770 nm. In another embodiment, at least one of the core layer and the intermediate layer comprises cerium oxide nanoparticles having a particle size of from about 370 nm to about 770 nm. In yet another embodiment, only the core layer comprises the cerium oxide nanoparticles. In still another embodiment, only the intermediate layer comprises the cerium oxide nanoparticles.

In another aspect of the invention, the golf ball comprises a core, a cover and an intermediate layer disposed between the core and the cover wherein at least one of the intermediate layer and the cover is formed from a moisture vapor barrier composition comprising cerium oxide nanoparticles having a particle size of from about 370 nm to about 800 nm. Alternatively, the core comprises an outer core layer and only the outer core layer is formed from the moisture vapor barrier composition. In yet another embodiment, only the intermediate layer is formed from the moisture vapor barrier composition.

In another aspect of the invention, the golf ball comprises a core comprising an inner core layer and an outer core layer, a cover and optionally an intermediate layer disposed between the outer core layer and the cover wherein at least one of the outer core layer and the intermediate layer is formed from a moisture vapor barrier composition comprising cerium oxide nanoparticles having a particle size of from about 1 nm to about 370 nm. Alternatively, only the outer core layer is formed from the moisture vapor barrier composition. In yet another embodiment, only the intermediate layer is formed from the moisture vapor barrier composition.

In another embodiment, the golf ball comprises a core, a cover and a moisture barrier layer disposed between the core and the cover wherein the moisture vapor barrier layer has a moisture vapor transmission rate that is lower than that of the cover and the moisture vapor barrier layer is formed from a vapor barrier composition comprising cerium oxide nanoparticles having a particle size of from about 370 nm to about 800 nm.

The moisture barrier layer may be an outer core layer, an intermediate layer, an inner cover layer, outer cover layer or even a coating.

The golf ball may also comprise a core comprising an untreated region and a treated outer surface, the treated outer surface having a first moisture vapor transmission rate and the untreated region having a second moisture vapor transmission rate, the treated outer surface being treated with a moisture vapor barrier composition formed from cerium oxide nanoparticles having a particle size of from about 370 nm to about 800 nm such that the first moisture vapor transmission rate is lower than the second moisture vapor transmission rate.

In another embodiment, the golf ball comprises a core and a cover disposed about the core wherein the cover comprises an inner surface and an outer surface, said outer surface being treated with a composition comprising cerium oxide nanoparticles having a particle size of from about 370 nm to about 800 nm such that a moisture vapor transmission rate X of the outer surface is lower than a moisture vapor transmission rate Y of the inner surface.

In yet another embodiment, the golf ball comprises a core and a cover disposed about the core wherein the cover comprises an inner surface and an outer surface, said inner surface being treated with a composition comprising cerium oxide nanoparticles having a particle size of from about 370 nm to about 800 nm such that a moisture vapor transmission rate X of the inner surface is lower than a moisture vapor transmission rate Y of the inner surface.

The golf ball mat also comprising a core and a cover disposed about the core, wherein the cover comprises an inner cover layer and an outer cover layer, said inner cover layer having a moisture vapor transmission rate X and the outer cover layer having a moisture vapor transmission rate Y, the outer cover layer comprising a moisture vapor barrier composition formed from a composition comprising cerium oxide nanoparticles having a particle size of from about 370 nm to about 800 nm such that X>Y. In one embodiment, Y≦0.95X. In another embodiment, Y≦0.75X. In yet another embodiment, Y≦5X. In still another embodiment, Y≦0.25X. In a further embodiment, Y≦0.10X.

The invention also relates to a method of manufacturing a golf ball yielding reduced UV degradation and/or durability and/or hydrophobicity. In one embodiment, the method comprises providing a core and forming a cover material by providing a prepolymer; combining the prepolymer with a curing agent and a white pigment to form a castable cover formulation; and then randomly dispersing into the castable cover formulation a substantially homogeneous particulate consisting of cerium oxide nanoparticles having a particle size of from about 370 nm to about 800 nm.

In another embodiment, the method comprises providing a core and coating the core with a substantially homogeneous composition consisting essentially of cerium oxide nanoparticles having a particle size of from about 370 nm to about 800 nm, and forming a cover about the coated core.

Another aspect of the invention is a method of making a golf ball comprising: providing a core; forming a cover composition by combining a prepolymer with a curing agent and a white pigment and then randomly dispersing a substantially homogeneous particulate consisting of cerium oxide nanoparticles having a particle size within the wavelength of visible light into the cover composition; and molding the cover about the core.

The method of making a golf ball may alternatively comprise providing a core; coating the core with a substantially homogeneous composition comprising cerium oxide nanoparticles having a particle size of from about 370 nm to about 800 nm; and forming a cover about the coated core.

Further, the method of manufacturing a golf ball may comprise: forming a core having an inner core layer and an outer core layer wherein said outer core layer comprises randomly dispersed cerium oxide nanoparticles having a particle size of from about 370 nm to about 800 nm; and forming a cover about the core.

In a different embodiment, the method of manufacturing a golf ball comprises:providing a core; forming an intermediate layer about the core, said intermediate layer comprising randomly dispersed cerium oxide nanoparticles having a particle size of from about 370 nm to about 800 nm; and forming a cover about the core.

In yet a different embodiment, the method of manufacturing a golf ball comprises providing a core; providing a cover material formed by combining a prepolymer, a curing agent and a white pigment and then randomly dispersing cerium oxide nanoparticles having a particle size of from about 370 nm to about 800 nm into the cover material; and forming the cover about the core.

Meanwhile, the method of manufacturing a golf ball may also comprise forming a core having an inner core layer and an outer core layer, said outer core layer comprising an ordered array of cerium oxide nanoparticles having a particle size of from about 370 nm to about 800 nm; and forming a cover about the core.

For any of the embodiments disclosed above and herein, the cover, an outer core layer, an intermediate layer, an inner cover layer or a coating may alternatively comprise either cerium oxide nanoparticles or the substantially homogenous particulate in an amount of from about 0.5 wt % to about 10 wt % of the layer/coating formulation. In one embodiment, the layer/coating comprises about 1 wt % of cerium oxide nanoparticles or substantially homogenous particulate. In another embodiment, the comprises about 1 wt % cerium oxide nanoparticles or substantially homogenous particulate. In yet another embodiment, the layer/coating comprises about 2 wt % of cerium oxide nanoparticles or substantially homogenous particulate. In still another embodiment, the layer/coating comprises about 3 wt % of cerium oxide nanoparticles or substantially homogenous particulate. In an alternative embodiment, the layer/coating comprises about 4 wt % of cerium oxide nanoparticles or substantially homogenous particulate. The layer/coating may also comprise from about 5 wt % to about 10 wt %, or from about 8 wt % to about 10 wt %, or from about 7 wt % to about 10 wt %, or from about 9 wt % to about 10 wt %, or from about 3 wt % to about 7 wt % or even from about 0.5 wt % to about 3 wt % of cerium oxide nanoparticles or substantially homogenous particulate.

In any or all of the embodiments disclosed herein, the cerium oxide nanoparticles may alternatively have a particle size of from about 370 nm to about 750 nm, or from about 400 nm to about 800 nm, or from about 400 nm to about 750 nm, or from about 380 nm to about 750 nm, or from about 400 nm to about 700 nm, or from about 625 nm to about 740 nm, or from about 590 nm to about 625 nm, or from about 565 nm to about 590 nm, or from about 520 nm to about 565 nm, or from about 500 nm to about 520 nm, or from about 435 nm to about 500 nm, or from about 380 nm to about 435 nm.

In one embodiment, the vapor barrier composition has a moisture vapor transmission rate of from about 0.45 grams·mm/m²·day to about 1.5 grams·mm/m²·day. In another embodiment, the vapor barrier composition has a moisture vapor transmission rate of about 0.95 grams·mm/m²·day or greater.

In general, the lower limit of Mooney viscosity of a composition comprising cerium oxide nanoparticles as described herein may be 30 or 35 or 40 or 45 or 50 or 55 or 60 or 70 or 75 and the upper limit may be 80 or 85 or 90 or 95 or 100 or 105 or 110 or 115 or 120 or 125 or 130.

In one embodiment, the overall golf ball has a compression of from about 25 to about 110. In another embodiment, the overall golf ball has a compression of from about 35 to about 100. In yet another embodiment, the overall golf ball has a compression of from about 45 to about 95. In still another embodiment, the compression may be from about 55 to about 85, or from about 65 to about 75. Meanwhile, the compression may also be from about 50 to about 110, or from about 60 to about 100, or from about 70 to about 90, or even from about 80 to about 110.

Generally, in golf balls of the invention, the overall golf ball COR is at least about 0.780. In another embodiment, the overall golf ball COR is at least about 0.788. In yet another embodiment, the overall golf ball COR is at least about 0.791. In still another embodiment, the overall golf ball COR is at least about 0.794. Also, the overall golf ball COR may be at least about 0.797. The overall golf ball COR may even be at least about 0.800, or at least about 0.803, or at least about 0.812.

Meanwhile, the inventive golf ball comprising cerium oxide nanoparticles as disclosed and claimed herein is versatile in that a wide range of Shore C and Shore D hardnesses may be chosen and coordinated for each of the core, core layers, intermediate layers and cover layers as known by thosed skilled in the golf ball art for achieving desired feel and playing characteristics. In this regard, cerium oxide nanoparticles will serve as filler in order to increase the density or specific gravity of a substrate into which they are mixed, whtehr it be an outer core layer, intermediate layer, inner cover layer, outer cover, or in a coating.

### DETAILED DESCRIPTION

The term “cerium oxide” (CeO₂) as used herein shall refer to any and all terms used interchangeably by those skilled in the art to denote CeO₂ including, for example, known as ceric oxide, ceria, or cerium dioxide, being an oxide of the rare earth metal cerium.

Herein, the phrase “substantially homogeneous particulate” means formed totally and solely of separate cerium oxide particles.

The term “randomly dispersed”, as used herein, shall refer to the cerium oxide nanoparticles being dispersed or distributed within the thermoset or theromoplastic cover composition irrespective and independently of the positioning or spacing of other components, elements, particles or any arrays incorporated within the cover composition.

The term “ordered array” as used herein shall refer to a deliberate pattern, spacing positioning or distribution of the cerium oxide nanoparticles within the thermoset or theromoplastic composition.

The cores in golf balls manufactured by the process of this invention may be solid, semi-solid, hollow, fluid-filled, or powder-filled. Typically, the cores are solid and made from rubber compositions containing at least a base rubber, free-radical initiator agent, cross-linking co-agent, and fillers. Golf balls having various constructions may be made in accordance with this invention. For example, golf balls having three-piece, four-piece, and five-piece constructions with dual or three-layered cores and cover materials may be made The term, “layer” as used herein means generally any spherical portion of the golf ball. More particularly, in one version, a three-piece golf ball comprising a core and a “dual-cover” is made. In another version, a four-piece golf ball comprising a dual-core and “dual-cover” is made. The dual-core includes an inner core (center) and surrounding outer core layer. The dual-cover includes inner cover and outer cover layers. In yet another construction, a five-piece golf ball having a dual-core, intermediate layer, and dual-cover is made. In still another embodiment, a four piece golf ball comprises a core and a three layer cover.

As used herein, the term, “intermediate layer” means a layer of the ball disposed between the core and cover. The intermediate layer may be considered an outer core layer, or inner cover layer, or any other layer disposed between the inner core and outer cover of the ball. The intermediate layer also may be referred to as a casing or mantle layer. The diameter and thickness of the different layers along with properties such as hardness and compression may vary depending upon the construction and desired playing performance properties of the golf ball and as specified herein.

The inner core of the golf ball may comprise a polybutadiene rubber material. In one embodiment, the ball contains a single core formed of the polybutadiene rubber composition. In a second embodiment, the ball contains a dual-core comprising an inner core (center) and surrounding outer core layer. In yet another version, the golf ball contains a multi-layered core comprising an inner core, intermediate core layer, and outer core layer.

In general, polybutadiene is a homopolymer of 1,3-butadiene. The double bonds in the 1,3-butadiene monomer are attacked by catalysts to grow the polymer chain and form a polybutadiene polymer having a desired molecular weight. Any suitable catalyst may be used to synthesize the polybutadiene rubber depending upon the desired properties. Normally, a transition metal complex (for example, neodymium, nickel, or cobalt) or an alkyl metal such as alkyllithium is used as a catalyst. Other catalysts include, but are not limited to, aluminum, boron, lithium, titanium, and combinations thereof The catalysts produce polybutadiene rubbers having different chemical structures. In a cis-bond configuration, the main internal polymer chain of the polybutadiene appears on the same side of the carbon-carbon double bond contained in the polybutadiene. In a trans-bond configuration, the main internal polymer chain is on opposite sides of the internal carbon-carbon double bond in the polybutadiene. The polybutadiene rubber can have various combinations of cis- and trans-bond structures. A preferred polybutadiene rubber has a 1,4 cis-bond content of at least 40%, preferably greater than 80%, and more preferably greater than 90%. In general, polybutadiene rubbers having a high 1, 4 cis-bond content have high tensile strength. The polybutadiene rubber may have a relatively high or low Mooney viscosity.

Examples of commercially available polybutadiene rubbers that can be used in accordance with this invention, include, but are not limited to, BR 01 and BR 1220, available from BST Elastomers of Bangkok, Thailand; SE BR 1220LA and SE BR1203, available from DOW Chemical Co of Midland, Mich.; BUDENE 1207, 1207s, 1208, and 1280 available from Goodyear, Inc of Akron, Ohio; BR 01, 51 and 730, available from Japan Synthetic Rubber (JSR) of Tokyo, Japan; BUNA CB 21, CB 22, CB 23, CB 24, CB 25, CB 29 MES, CB 60, CB Nd 60, CB 55 NF, CB 70 B, CB KA 8967, and CB 1221, available from Lanxess Corp. of Pittsburgh. Pa.; BR1208, available from LG Chemical of Seoul, South Korea; UBEPOL BR130B, BR150, BR150B, BR150L, BR230, BR360L, BR710, and VCR617, available from UBE Industries, Ltd. of Tokyo, Japan; EUROPRENE NEOCIS BR 60, INTENE 60 AF and P3OAF, and EUROPRENE BR HV80, available from Polimeri Europa of Rome, Italy; AFDENE 50 and NEODENE BR40, BR45, BR50 and BR60, available from Karbochem (PTY) Ltd. of Bruma, South Africa; KBR 01, NdBr 40, NdBR-45, NdBr 60, KBR 710S, KBR 710H, and KBR 750, available from Kumho Petrochemical Co., Ltd. Of Seoul, South Korea; DIENE 55NF, 70AC, and 320 AC, available from Firestone Polymers of Akron, Ohio; and PBR-Nd Group II and Group III, available from Nizhnekamskneftekhim, Inc. of Nizhnekamsk, Tartarstan Republic.

Suitable polybutadiene rubbers for blending with the base rubber may include BUNA® CB22, BUNA® CB23 and BUNA® CB24, BUNA ® 1203G1, 1220, 1221, and BUNA ® CBNd-40, commercially available from LANXESS Corporation; BSTE BR-1220 available from BST Elastomers Co. LTD; UBEPOL® 360L and UBEPOL® 150L and UBEPOL-BR rubbers, commercially available from UBE Industries, Ltd. of Tokyo, Japan; Budene 1207, 1208 and 1280, commercially available from Goodyear of Akron, Ohio; SE BR-1220, commercially available from Dow Chemical Company; Europrene® NEOCIS® BR 40 and BR 60, commercially available from Polimeri Europa; and BR 01, BR 730, BR 735, BR 11, and BR 51, commercially available from Japan Synthetic Rubber Co., Ltd; and KARBOCHEM® Neodene 40, 45, and 60, commercially available from Karbochem.

The base rubber may further include polyisoprene rubber, natural rubber, ethylene-propylene rubber, ethylene-propylene diene rubber, styrene-butadiene rubber, and combinations of two or more thereof. Another preferred base rubber is polybutadiene optionally mixed with one or more elastomers such as polyisoprene rubber, natural rubber, ethylene propylene rubber, ethylene propylene diene rubber, styrene-butadiene rubber, polystyrene elastomers, polyethylene elastomers, polyurethane elastomers, polyurea elastomers, acrylate rubbers, polyoctenamers, metallocene-catalyzed elastomers, and plastomers. As discussed further below, highly neutralized acid copolymers (HNPs), as known in the art, also can be used to form the core layer as part of the blend. Such compositions will provide increased flexural modulus and toughness thereby improving the golf ball's performance including its impact durability. The base rubber typically is mixed with at least one reactive cross-linking co-agent to enhance the hardness of the rubber composition. Suitable co-agents include, but are not limited to, unsaturated carboxylic acids and unsaturated vinyl compounds. A preferred unsaturated vinyl compound is trimethylolpropane trimethacrylate. The rubber composition is cured using a conventional curing process. Suitable curing processes include, for example, peroxide curing, sulfur curing, high-energy radiation, and combinations thereof. In one embodiment, the base rubber is peroxide cured. Organic peroxides suitable as free-radical initiators include, for example, dicumyl peroxide; n-butyl-4,4-di(t-butylperoxy)valerate; 1,1-di(t-butylperoxy)3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. Cross-linking agents are used to cross-link at least a portion of the polymer chains in the composition. Suitable cross-linking agents include, for example, metal salts of unsaturated carboxylic acids having from 3 to 8 carbon atoms; unsaturated vinyl compounds and polyfunctional monomers (for example, trimethylolpropane trimethacrylate); phenylene bismaleimide; and combinations thereof. In a particular embodiment, the cross-linking agent is selected from zinc salts of acrylates, diacrylates, methacrylates, and dimethacrylates. In another particular embodiment, the cross-linking agent is zinc diacrylate (“ZDA”). Commercially available zinc diacrylates include those selected from Cray Valley Resource Innovations Inc. Other elastomers known in the art may also be added, such as other polybutadiene rubbers, natural rubber, styrene butadiene rubber, and/or isoprene rubber in order to further modify the properties of the core. When a mixture of elastomers is used, the amounts of other constituents in the core composition are typically based on 100 parts by weight of the total elastomer mixture.

Thermoplastic elastomers (TPE) may also be used to modify the properties of the core layers, or the uncured core layer stock by blending with the uncured rubber. These TPEs include natural or synthetic balata, or high trans-polyisoprene, high trans-polybutadiene, or any styrenic block copolymer, such as styrene ethylene butadiene styrene, styrene-isoprene-styrene, etc., a metallocene or other single-site catalyzed polyolefin such as ethylene-octene, or ethylene-butene, or thermoplastic polyurethanes (TPU), including copolymers, e.g. with silicone. Other suitable TPEs for blending with the thermoset rubbers of the present invention include PEBAX®, which is believed to comprise polyether amide copolymers, HYTREL®, which is believed to comprise polyether ester copolymers, thermoplastic urethane, and KRATON®, which is believed to comprise styrenic block copolymers elastomers. Any of the TPEs or TPUs above may also contain functionality suitable for grafting, including maleic acid or maleic anhydride. Any of the Thermoplastic Vulcanized Rubbers (TPV) such as Santoprene® or Vibram® or ETPV® can be used along with a present invention. In one embodiement, the TPV has a thermoplastic as a continuous phase and a cross-linked rubber particulate as a dispersed (or discontinuous) phase. In another emobodiment, the TPV has a cross-linked phase as a continuous phase and a thermoplasttic as a dispersed (or discontinuous) phase to provide reduced loss in elasticity in order to improve the resiliency of the golf ball.

The rubber compositions also may contain “soft and fast” agents such as a halogenated organosulfur, organic disulfide, or inorganic disulfide compounds. Particularly suitable halogenated organosulfur compounds include, but are not limited to, halogenated thiophenols. Preferred organic sulfur compounds include, but not limited to, pentachlorothiophenol (“PCTP”) and a salt of PCTP. A preferred salt of PCTP is ZnPCTP. A suitable PCTP is sold by the Struktol Company (Stow, OH) under the tradename, A95. ZnPCTP is commercially available from EchinaChem (San Francisco, Calif.). These compounds also may function as cis-to-trans catalysts to convert some cis bonds in the polybutadiene to trans bonds. Antioxidants also may be added to the rubber compositions to prevent the breakdown of the elastomers. Other ingredients such as accelerators (for example, tetra methylthiuram), processing aids, dyes and pigments, wetting agents, surfactants, plasticizers, as well as other additives known in the art may be added to the rubber composition.

The core may be formed by mixing and forming the rubber composition using conventional techniques. These cores can be used to make finished golf balls by surrounding the core with outer core layer(s), intermediate layer(s), and/or cover materials as discussed further below. In another embodiment, the cores can be formed using highly neutralized polymer (HNP) compositions as disclosed in U.S. Pat. Nos. 6,756,436, 7,030,192, 7,402,629, and 7,517,289. The cores from the highly neutralized polymer compositions can be further cross-linked using any free-radical initiation sources including radiation sources such as gamma or electron beam as well as chemical sources such as peroxides and the like.

Golf balls made in accordance with this invention can be of any size, although the USGA requires that golf balls used in competition have a diameter of at least 1.68 inches and a weight of no greater than 1.62 ounces. For play outside of USGA competition, the golf balls can have smaller diameters and be heavier.

A wide variety of thermoplastic or thermosetting materials can be employed in forming the core, cover layers, or both. These materials include for example, olefin-based copolymer ionomer resins (for example, Surlyn® ionomer resins and DuPont® HPF 1000 and HPF 2000, as well as blends of Surlyn®7940/Surlyn®8940 or Surlyn®8150/Surlyn®9150 commercially available from E. I. du Pont de Nemours and Company; Iotek® ionomers, commercially available from ExxonMobil Chemical Company; Amplify® IO ionomers of ethylene acrylic acid copolymers, commercially available from The Dow Chemical Company; and Clarix® ionomer resins, commercially available from A. Schulman Inc.); polyurethanes; polyureas; copolymers and hybrids of polyurethane and polyurea; polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer and polyamide including, for example, Pebax® thermoplastic polyether block amides, commercially available from Arkema Inc; cross-linked trans-polyisoprene and blends thereof; polyester-based thermoplastic elastomers, such as Hytrel®, commercially available from E. I. du Pont de Nemours and Company; polyurethane-based thermoplastic elastomers, such as Elastollan®, commercially available from BASF; synthetic or natural vulcanized rubber; and combinations thereof.

In fact, any of the core, intermediate layer and/or cover layers may include the following materials:

(1) Polyurethanes, such as those prepared from polyols and diisocyanates or polyisocyanates and/or their prepolymers;

(2) Polyureas; and

(3) Polyurethane-urea hybrids, blends or copolymers comprising urethane and urea segments.

Polyurethanes and polyureas may constitute either thermoset or thermoplastic compositions, depending on the type of crosslinking bond that is created during formation of the composition. When a polyurethane or polyurea prepolymer is cross linked with a polyfunctional curing agent, covalent bonding occurs, resulting in a thermoset composition. In contrast, polyurethanes and polyureas will be thermoplastic where the crosslinking is due, for example, to hydrogen bonding, resulting in weaker bonds which may be broken upon heating the composition. This distinction explains why thermoset materials generally may not be reclycled or reformed into a different shape by heating (at least not easily), whereas thermoplastic materials may so be. The process for manufacturing a golf ball according to the invention is particularly well-suited for forming golf balls having a combination of a very thin, thermoplastic outer cover and a thermoset inner cover having a thickness greater than that of the outer cover layer, providing both COR stability and playability.

Suitable polyurethane compositions comprise a reaction product of at least one polyisocyanate and at least one curing agent. The curing agent can include, for example, one or more polyamines, one or more polyols, or a combination thereof. The polyisocyanate can be combined with one or more polyols to form a prepolymer, which is then combined with the at least one curing agent. Thus, the polyols described herein are suitable for use in one or both components of the polyurethane material, i.e., as part of a prepolymer and in the curing agent. Suitable polyurethanes are described in U.S. Patent Application Publication No. 2005/0176523, which is incorporated by reference in its entirety.

Any polyisocyanate available to one of ordinary skill in the art is suitable for use according to the invention. Exemplary polyisocyanates include, but are not limited to, 4,4′-diphenylmethane diisocyanate (MDI); polymeric MDI; carbodiimide-modified liquid MDI; 4,4′-dicyclohexylmethane diisocyanate (H₁₂MDI); p-phenylene diisocyanate (PPDI); m-phenylene diisocyanate (MPDI); toluene diisocyanate (TDI); 3,3′-dimethyl-4,4′-biphenylene diisocyanate; isophoronediisocyanate; 1,6-hexamethylene diisocyanate (HDI); naphthalene diisocyanate; xylene diisocyanate; p-tetramethylxylene diisocyanate; m-tetramethylxylene diisocyanate; ethylene diisocyanate; propylene-1,2-diisocyanate; tetramethylene-1,4-diisocyanate; cyclohexyl diisocyanate; dodecane-1,12-diisocyanate; cyclobutane-1,3-diisocyanate; cyclohexane-1,3-diisocyanate; cyclohexane-1,4-diisocyanate; 1-isocyanato-3,3,5-trimethyl-5-isocyanatomethylcyclohexane; methyl cyclohexylene diisocyanate; triisocyanate of HDI; triisocyanate of 2,4,4-trimethyl-1,6-hexane diisocyanate; tetracene diisocyanate; napthalene diisocyanate; anthracene diisocyanate; isocyanurate of toluene diisocyanate; uretdione of hexamethylene diisocyanate; and mixtures thereof. Polyisocyanates are known to those of ordinary skill in the art as having more than one isocyanate group, e.g., di-isocyanate, tri-isocyanate, and tetra-isocyanate. Preferably, the polyisocyanate includes MDI, PPDI, TDI, or a mixture thereof, and more preferably, the polyisocyanate includes MDI. It should be understood that, as used herein, the term MDI includes 4,4′-diphenylmethane diisocyanate, polymeric MDI, carbodiimide-modified liquid MDI, and mixtures thereof. Additionally, the prepolymers synthesized from these diisocyanates may be “low free monomer,” understood by one of ordinary skill in the art to have lower levels of “free” isocyanate monomers, typically less than about 0.1% free isocyanate. Examples of “low free monomer” prepolymers include, but are not limited to Low Free Monomer MDI prepolymers, Low Free Monomer TDI prepolymers, and Low Free Monomer PPDI prepolymers.

Any polyol available to one of ordinary skill in the art is suitable for use according to the invention. Exemplary polyols include, but are not limited to, polyether polyols, hydroxy-terminated polybutadiene (including partially/fully hydrogenated derivatives), polyester polyols, polycaprolactone polyols, and polycarbonate polyols. In one preferred embodiment, the polyol includes polyether polyol. Examples include, but are not limited to, polytetramethylene ether glycol (PTMEG), polyethylene propylene glycol, polyoxypropylene glycol, and mixtures thereof. The hydrocarbon chain can have saturated or unsaturated bonds and substituted or unsubstituted aromatic and cyclic groups. Preferably, the polyol of the present invention includes PTMEG.

In another embodiment, polyester polyols are included in the polyurethane material. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. The hydrocarbon chain can have saturated or unsaturated bonds, or substituted or unsubstituted aromatic and cyclic groups.

In another embodiment, polycaprolactone polyols are included in the materials of the invention. Suitable polycaprolactone polyols include, but are not limited to, 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups.

In yet another embodiment, polycarbonate polyols are included in the polyurethane material of the invention. Suitable polycarbonates include, but are not limited to, polyphthalate carbonate and poly(hexamethylene carbonate) glycol. The hydrocarbon chain can have saturated or unsaturated bonds, or substituted or unsubstituted aromatic and cyclic groups. In one embodiment, the molecular weight of the polyol is from about 200 to about 4000.

Polyamine curatives are also suitable for use in the polyurethane composition of the invention and have been found to improve cut, shear, and impact resistance of the resultant balls. Preferred polyamine curatives include, but are not limited to, 3,5-dimethylthio-2,4-toluenediamine and isomers thereof; 3,5-diethyltoluene-2,4-diamine and isomers thereof, such as 3,5-diethyltoluene-2,6-diamine; 4,4′-bis-(sec-butylamino)-diphenylmethane; 1,4-bis-(sec-butylamino)-benzene, 4,4′-methylene-bis-(2-chloroaniline); 4,4′-methylene-bis-(3-chloro-2,6-diethylaniline); polytetramethyleneoxide-di-p-aminobenzoate; N,N′-dialkyldiamino diphenyl methane; p,p′-methylene dianiline; m-phenylenediamine; 4,4′-methylene-bis-(2-chloroaniline); 4,4′-methylene-bis-(2,6-diethylaniline); 4,4′-methylene-bis-(2,3-dichloroaniline); 4,4′-diamino-3,3′-diethyl-5,5′-dimethyl diphenylmethane; 2,2′,3,3′-tetrachloro diamino diphenylmethane; trimethylene glycol di-p-aminobenzoate; and mixtures thereof. Preferably, the curing agent of the present invention includes 3,5-dimethylthio-2,4-toluenediamine and isomers thereof, such as ETHACURE® 300, commercially available from Albermarle Corporation of Baton Rouge, La. Suitable polyamine curatives, which include both primary and secondary amines, preferably have molecular weights ranging from about 64 to about 2000.

At least one of a diol, triol, tetraol, or hydroxy-terminated curatives may be added to the aforementioned polyurethane composition. Suitable diol, triol, and tetraol groups include ethylene glycol; diethylene glycol; polyethylene glycol; propylene glycol; polypropylene glycol; lower molecular weight polytetramethylene ether glycol; 1,3-bis(2-hydroxyethoxy)benzene; 1,3-bis-[2-(2-hydroxyethoxy)ethoxy]benzene; 1,3-bis-{2-[2-(2-hydroxyethoxy)ethoxy]ethoxy}benzene; 1,4-butanediol; 1,5-pentanediol; 1,6-hexanediol; resorcinol-di-(β-hydroxyethyl)ether; hydroquinone-di-(β-hydroxyethyl)ether; and mixtures thereof. Preferred hydroxy-terminated curatives include 1,3-bis(2-hydroxyethoxy)benzene; 1,3-bis-[2-(2-hydroxyethoxy)ethoxy]benzene; 1,3-bis-{2-[2-(2-hydroxyethoxy)ethoxy]ethoxy}benzene; 1,4-butanediol, and mixtures thereof. Preferably, the hydroxy-terminated curatives have molecular weights ranging from about 48 to 2000. It should be understood that molecular weight, as used herein, is the absolute weight average molecular weight and would be understood as such by one of ordinary skill in the art.

Both the hydroxy-terminated and amine curatives can include one or more saturated, unsaturated, aromatic, and cyclic groups. Additionally, the hydroxy-terminated and amine curatives can include one or more halogen groups. The polyurethane composition can be formed with a blend or mixture of curing agents. If desired, however, the polyurethane composition may be formed with a single curing agent.

In one embodiment of the present invention, saturated polyurethanes are used to foam one or more of the cover layers.

Additionally, polyurethane can be replaced with or blended with a polyurea material. Polyureas are distinctly different from polyurethane compositions, giving better shear resisitance.

The polyether amine may be blended with additional polyols to formulate copolymers that are reacted with excess isocyanate to form the polyurea prepolymer. In one embodiment, less than about 30 percent polyol by weight of the copolymer is blended with the saturated polyether amine. In another embodiment, less than about 20 percent polyol by weight of the copolymer, preferably less than about 15 percent by weight of the copolymer, is blended with the polyether amine. The polyols listed above with respect to the polyurethane prepolymer, e.g., polyether polyols, polycaprolactone polyols, polyester polyols, polycarbonate polyols, hydrocarbon polyols, other polyols, and mixtures thereof, are also suitable for blending with the polyether amine. The molecular weight of these polymers may be from about 200 to about 4000, but also may be from about 1000 to about 3000, and more preferably are from about 1500 to about 2500.

The polyurea composition can be formed by crosslinking a polyurea prepolymer with a single curing agent or a blend of curing agents. In one embodiment, the amine-terminated curing agent may have a molecular weight of about 64 or greater. In another embodiment, the molecular weight of the amine-curing agent is about 2000 or less. As discussed above, certain amine-terminated curing agents may be modified with a compatible amine-terminated freezing point depressing agent or mixture of compatible freezing point depressing agents

Suitable amine-terminated curing agents include, but are not limited to, ethylene diamine; hexamethylene diamine; 1-methyl-2,6-cyclohexyl diamine; tetrahydroxypropylene ethylene diamine; 2,2,4- and 2,4,4-trimethyl-1,6-hexanediamine; 4,4′-bis-(sec-butylamino)-dicyclohexylmethane; 1,4-bis-(sec-butylamino)-cyclohexane; 1,2-bis-(sec-butylamino)-cyclohexane; derivatives of 4,4′-bis-(sec-butylamino)-dicyclohexylmethane; 4,4′-dicyclohexylmethane diamine; 1,4-cyclohexane-bis-(methylamine); 1,3-cyclohexane-bis-(methylamine); diethylene glycol di-(aminopropyl)ether; 2-methylpentamethylene-diamine; diaminocyclohexane; diethylene triamine; triethylene tetramine; tetraethylene pentamine; propylene diamine; 1,3-diaminopropane; dimethylamino propylamine; diethylamino propylamine; dipropylene triamine; imido-bis-propylamine; monoethanolamine, diethanolamine; 3,5-diethyltoluene-2,4-diamine; triethanolamine; monoisopropanolamine, diisopropanolamine; isophoronediamine; 4,4′-methylenebis-(2-chloroaniline); 3,5-dimethylthio-2,4-toluenediamine; 3,5-dimethylthio-2,6-toluenediamine; 3,5-diethylthio-2,4-toluenediamine; 3,5-diethylthio-2,6-toluenediamine; 4,4′-bis-(sec-butylamino)-diphenylmethane and derivatives thereof; 1,4-bis-(sec-butylamino)-benzene; 1,2-bis-(sec-butylamino)-benzene; N,N′-dialkylamino-diphenylmethane; N,N,N′,N′-tetrakis (2-hydroxypropyl)ethylene diamine; trimethyleneglycol-di-p-aminobenzoate; polytetramethyleneoxide-di-p-aminobenzoate; 4,4′-methylenebis-(3-chloro-2,6-diethyleneaniline); 4,4′-methylenebis-(2,6-diethylaniline); meta-phenylenediamine; paraphenylenediamine; and mixtures thereof. In one embodiment, the amine-terminated curing agent is 4,4′-bis-(sec-butylamino)-dicyclohexylmethane.

Suitable saturated amine-terminated curing agents include, but are not limited to, ethylene diamine; hexamethylene diamine; 1-methyl-2,6-cyclohexyl diamine; tetrahydroxypropylene ethylene diamine; 2,2,4- and 2,4,4-trimethyl-1,6-hexanediamine; 4,4′-bis-(sec-butylamino)-dicyclohexylmethane; 1,4-bis-(sec-butylamino)-cyclohexane; 1,2-bis-(sec-butylamino)-cyclohexane; derivatives of 4,4′-bis-(sec-butylamino)-dicyclohexylmethane; 4,4′-dicyclohexylmethane diamine; 4,4′-methylenebis-(2,6-diethylaminocyclohexane; 1,4-cyclohexane-bis-(methylamine); 1,3-cyclohexane-bis-(methylamine); diethylene glycol di-(aminopropyl) ether; 2-methylpentamethylene-diamine; diaminocyclohexane; diethylene triamine; triethylene tetramine; tetraethylene pentamine; propylene diamine; 1,3-diaminopropane; dimethylamino propylamine; diethylamino propylamine; imido-bis-propylamine; monoethanolamine, diethanolamine; triethanolamine; monoisopropanolamine, diisopropanolamine; isophoronediamine; triisopropanolamine; and mixtures thereof In addition, any of the polyether amines listed above may be used as curing agents to react with the polyurea prepolymers.

Alternatively, other suitable polymers include partially or fully neutralized ionomer, metallocene, or other single-site catalyzed polymer, polyester, polyamide, non-ionomeric thermoplastic elastomer, copolyether-esters, copolyether-amides, polycarbonate, polybutadiene, polyisoprene, polystryrene block copolymers (such as styrene-butadiene-styrene), styrene-ethylene-propylene-styrene, styrene-ethylene-butylene-styrene, and the like, and blends thereof.

Intermediate layers and/or cover layers may also be formed from ionomeric polymers or ionomer blends such as Surlyn 7940/8940 or Surlyn 8150/9150 or from highly-neutralized ionomers (HNP).

In one embodiment, at least one intermediate layer of the golf ball is formed from an HNP material or a blend of HNP materials. The acid moieties of the HNP's, typically ethylene-based ionomers, are preferably neutralized greater than about 70%, more preferably greater than about 90%, and most preferably at least about 100% with a cation source. Suitable cation sources include metal cations and salts thereof, organic amine compounds, ammonium, and combinations thereof. The HNP's can be also be blended with a second polymer component, which, if containing an acid group(s) such as organic acids, or more preferably fatty acids, may be neutralized in a conventional manner, with a suitable cation source. The second polymer component, which may be partially or fully neutralized, preferably comprises ionomeric copolymers and terpolymers, ionomer precursors, thermoplastics, polyamides, polycarbonates, polyesters, polyurethanes, polyureas, thermoplastic elastomers, polybutadiene rubber, balata, metallocene-catalyzed polymers (grafted and non-grafted), single-site polymers, high-crystalline acid polymers, cationic ionomers, and the like. HNP polymers typically have a material hardness of between about 20 and about 80 Shore D, and a flexural modulus of between about 3,000 psi and about 200,000 psi.

In one embodiment of the present invention the HNP's are ionomers and/or their acid precursors that are preferably neutralized, either fully or partially, with sufficient amount of metal base to achieve the desired neutralization level. The acid copolymers are preferably a-olefin, such as ethylene, C₃₋₈ α,β-ethylenically unsaturated carboxylic acid, such as acrylic and methacrylic acid, copolymers. They may optionally contain a softening monomer, such as alkyl acrylate and alkyl methacrylate, wherein the alkyl groups have from 1 to 8 carbon atoms.

The acid copolymers can be described as E/X/Y copolymers where E is ethylene, X is an α,β-ethylenically unsaturated carboxylic acid, and Y is a softening comonomer. In a preferred embodiment, X is acrylic or methacrylic acid and Y is a C₁₋₈ alkyl acrylate or methacrylate ester. X is preferably present in an amount from about 1 to about 35 weight percent of the polymer, more preferably from about 5 to about 30 weight percent of the polymer, and most preferably from about 10 to about 20 weight percent of the polymer. Y is preferably present in an amount from about 0 to about 50 weight percent of the polymer, more preferably from about 5 to about 25 weight percent of the polymer, and most preferably from about 10 to about 20 weight percent of the polymer.

Specific acid-containing ethylene copolymers include, but are not limited to, ethylene/acrylic acid/n-butyl acrylate, ethylene/methacrylic acid/n-butyl acrylate, ethylene/methacrylic acid/iso-butyl acrylate, ethylene/acrylic acid/iso-butyl acrylate, ethylene/methacrylic acid/n-butyl methacrylate, ethylene/acrylic acid/methyl methacrylate, ethylene/acrylic acid/methyl acrylate, ethylene/methacrylic acid/methyl acrylate, ethylene/methacrylic acid/methyl methacrylate, and ethylene/acrylic acid/n-butyl methacrylate. Preferred acid-containing ethylene copolymers include, ethylene/methacrylic acid/n-butyl acrylate, ethylene/acrylic acid/n-butyl acrylate, ethylene/methacrylic acid/methyl acrylate, ethylene/acrylic acid/ethyl acrylate, ethylene/methacrylic acid/ethyl acrylate, and ethylene/acrylic acid/methyl acrylate copolymers. The most preferred acid-containing ethylene copolymers are, ethylene/(meth) acrylic acid/n-butyl, acrylate, ethylene/(meth)acrylic acid/ethyl acrylate, and ethylene/(meth) acrylic acid/methyl acrylate copolymers.

Ionomers are typically neutralized with a metal cation, such as Li, Na, Mg, K, Ca, or Zn. It has been found that by adding sufficient organic acid or salt of organic acid, along with a suitable base, to the acid copolymer or ionomer, the ionomer can be neutralized, without losing processability, to a level much greater than for a metal cation alone. Preferably, the acid moieties are neutralized greater than about 80%, preferably from 90-100%, most preferably 100% without losing processability. This is accomplished by melt-blending an ethylene α,β-ethylenically unsaturated carboxylic acid copolymer, for example, with an organic acid or a salt of organic acid, and adding a sufficient amount of a cation source to increase the level of neutralization of all the acid moieties (including those in the acid copolymer and in the organic acid) to greater than 90%, (preferably greater than 100%).

The organic acids may be aliphatic, mono- or multi-functional (saturated, unsaturated, or multi-unsaturated) organic acids. Salts of these organic acids may also be employed. The salts of organic acids of the present invention include the salts of barium, lithium, sodium, zinc, bismuth, chromium, cobalt, copper, potassium, strontium, titanium, tungsten, magnesium, cesium, iron, nickel, silver, aluminum, tin, or calcium, salts of fatty acids, particularly stearic, behenic, erucic, oleic, linoelic or dimerized derivatives thereof It is preferred that the organic acids and salts of the present invention be relatively non-migratory (they do not bloom to the surface of the polymer under ambient temperatures) and non-volatile (they do not volatilize at temperatures required for melt-blending).

The ionomers may also be more conventional ionomers, i.e., partially-neutralized with metal cations. The acid moiety in the acid copolymer is neutralized about 1 to about 90%, preferably at least about 20 to about 75%, and more preferably at least about 40 to about 70%, to form an ionomer, by a cation such as lithium, sodium, potassium, magnesium, calcium, barium, lead, tin, zinc, aluminum, or a mixture thereof.

The golf ball may also contain additives, ingredients, and other materials in amounts that do not detract from the properties of the final composition. These additive materials include, but are not limited to, activators such as calcium or magnesium oxide; fatty acids such as stearic acid and salts thereof; fillers and reinforcing agents such as organic or inorganic particles, for example, clays, talc, calcium, magnesium carbonate, silica, aluminum silicates, zeolites, powdered metals, and organic or inorganic fibers, plasticizers such as dialkyl esters of dicarboxylic acids; surfactants; softeners; tackifiers; waxes; ultraviolet (UV) light absorbers and stabilizers; antioxidants; optical brighteners; whitening agents such as titanium dioxide and zinc oxide; dyes and pigments; processing aids; release agents; and wetting agents. These compositions provide improved melt processability, and a balance of ball performance.

Blowing/foaming agents may also be particularly compatible with the golf ball produced by the process of the invention, including, for example those disclosed in U.S. Pat. No. 7,708,654. Typical physical foaming/blowing agents include volatile liquids such as freons (CFCs), other halogenated hydrocarbons, water, aliphatic hydrocarbons, gases, and solid blowing agents, i.e., compounds that liberate gas as a result of desorption of gas. Preferably, the blowing agent includes an adsorbent. Typical adsorbents include, for example, activated carbon, calcium carbonate, diatomaceous earth, and silicates saturated with carbon dioxide.

Chemical foaming/blowing agents may be incorporated. Chemical blowing agents may be inorganic, such as ammonium carbonate and carbonates of alkalai metals, or may be organic, such as azo and diazo compounds, such as nitrogen-based azo compounds. Suitable azo compounds include, but are not limited to, 2,2′-azobis(2-cyanobutane), 2,2′-azobis(methylbutyronitrile), azodicarbonamide, p,p′-oxybis(benzene sulfonyl hydrazide), p-toluene sulfonyl semicarbazide, p-toluene sulfonyl hydrazide. Other blowing agents include any of the Celogens®, sold by Crompton Chemical Corporation, and nitroso compounds, sulfonylhydrazides, azides of organic acids and their analogs, triazines, tri- and tetrazole derivatives, sulfonyl semicarbazides, urea derivatives, guanidine derivatives, and esters such as alkoxyboroxines. Other possible blowing agents include agents that liberate gasses as a result of chemical interaction between components such as mixtures of acids and metals, mixtures of organic acids and inorganic carbonates, mixtures of nitriles and ammonium salts, and the hydrolytic decomposition of urea.

Alternatively, low specific gravity can be achieved by incorporating low density fillers or agents such as hollow fillers or microspheres in the polymeric matrix, where the cured composition has the preferred specific gravity. Moreover, the polymeric matrix can be foamed to decrease its specific gravity, microballoons, or other low density fillers as described in U.S. Pat. No. 6,692,380 (“'380 Patent”). The '380 patent is incorporated by reference in its entirety.

Blends including non-ionomeric and olefin-based ionomeric polymers may also be incorporated to form a golf ball layer. Examples of non-ionomeric polymers include vinyl resins, polyolefins including those produced using a single-site catalyst or a metallocene catalyst, polyurethanes, polyureas, polyamides, polyphenylenes, polycarbonates, polyesters, polyacrylates, engineering thermoplastics, and the like. Also, in one embodiment of the invention, processability of the golf ball of the invention may even be enhanced by incorporating in the core a metallocene-catalyzed polybutadiene.

Olefin-based ionomers, such as ethylene-based copolymers, normally include an unsaturated carboxylic acid, such as methacrylic acid, acrylic acid, or maleic acid. Other possible carboxylic acid groups include, for example, crotonic, maleic, fumaric, and itaconic acid. “Low acid” and “high acid” olefin-based ionomers, as well as blends of such ionomers, may be used. In general, low acid ionomers are considered to be those containing 16 wt. % or less of carboxylic acid, whereas high acid ionomers are considered to be those containing greater than 16 wt. % of carboxylic acid. The acidic group in the olefin-based ionic copolymer is partially or totally neutralized with metal ions such as zinc, sodium, lithium, magnesium, potassium, calcium, manganese, nickel, chromium, copper, or a combination thereof For example, ionomeric resins having carboxylic acid groups that are neutralized from about 10 percent to about 100 percent may be used. In one embodiment, the acid groups are partially neutralized. That is, the neutralization level is from 10 to 80%, more preferably 20 to 70%, and most preferably 30 to 50%. In another embodiment, the acid groups are highly or fully neutralized. Or, the neutralization level may be from about 80 to 100%, more preferably 90 to 100%, and most preferably 95 to 100%. The blend may contain about 5 to about 30% by weight of the moisture barrier composition and about 95 to about 70% by weight of a partially, highly, or fully-neutralized olefin-based ionomeric copolymer. The above-mentioned blends may contain one or more suitable compatibilizers such as glycidyl acrylate or glycidyl methacrylate or maleic anhydride containing-polymers.

In one embodiment, the overall golf ball produced by the process of the invention has a compression of from about 25 to about 110. In another embodiment, the overall golf ball has a compression of from about 35 to about 100. In yet another embodiment, the overall golf ball has a compression of from about 45 to about 95. In still another embodiment, the compression may be from about 55 to about 85, or from about 65 to about 75. Meanwhile, the compression may also be from about 50 to about 110, or from about 60 to about 100, or from about 70 to about 90, or even from about 80 to about 110.

Generally, in golf balls produced by the process of the invention, the overall golf ball COR is at least about 0.780. In another embodiment, the overall golf ball COR is at least about 0.788. In yet another embodiment, the overall golf ball COR is at least about 0.791. In still another embodiment, the overall golf ball COR is at least about 0.794. Also, the overall golf ball COR may be at least about 0.797. The overall golf ball COR may even be at least about 0.800, or at least about 0.803, or at least about 0.812.

The core, intermediate layer(s) and/or cover layers may contain sections having the same hardness or different hardness levels. That is, there can be uniform hardness throughout the different sections of the core or there can be hardness gradients across the layers. For example, in single cores, there may be a hard-to-soft gradient (a “positive” gradient) from the surface of the core to the geometric center of the core. In other instances, there may be a soft-to-hard gradient (a “negative” gradient) or zero hardness gradient from the core's surface to the core's center. For dual core golf balls, the inner core layer may have a surface hardness that is less than the geometric center hardness to define a first “negative” gradient. As discussed above, an outer core layer may be formed around the inner core layer, and the outer core layer may have an outer surface hardness less than its inner surface hardness to define a second “negative” gradient. In other versions, the hardness gradients from surface to center may be hard-to-soft (“positive”), or soft-to-hard (“negative”), or a combination of both gradients. In still other versions the hardness gradients from surface to center may be “zero” (that is, the hardness values are substantially the same.) Methods for making cores having positive, negative, and zero hardness gradients are known in the art as described in, for example, U.S. Pat. Nos. 7,537,530; 7,537,529; 7,427,242; and 7,410,429, the disclosures of which are hereby incorporated by reference.

A golf ball according to the invention may therefore achieve various hardness gradients therein. For example, the golf ball made by the process of the invention may be incorporate a single-solid core having a “positive” hardness gradient (that is, the outer surface of the core is harder than its geometric center.) In a second embodiment, the core may be a dual-core comprising an inner core and a surrounding outer core layer. The inner core has a “positive” hardness gradient and the outer core layer has a “negative” hardness gradient (that is, the outer surface of the outer core layer is softer than the inner surface of the outer core layer.) Other embodiments of golf balls having various combinations of positive, negative, and zero hardness gradients may be made in accordance with this invention. For example, the inner core may have a positive hardness gradient and the outer core layer also may have a positive hardness gradient. In another example, the inner core may have a positive hardness gradient and the outer core layer may have a “zero” hardness gradient. (That is, the hardness values of the outer surface of the outer core layer and the inner surface of the outer core layer are substantially the same.) Particularly, the term, “zero hardness gradient” as used herein, means a surface to center Shore C hardness gradient of less than 8, preferably less than 5 and most preferably less than 3 and may have a value of zero or negative 1 to negative 25. The term, “negative hardness gradient” as used herein, means a surface to center Shore C hardness gradient of less than zero. The terms, zero hardness gradient and negative hardness gradient, may be used herein interchangeably to refer to hardness gradients of negative 1 to negative 25. The term, “positive hardness gradient” as used herein, means a surface to center Shore C hardness gradient of 8 or greater, preferably 10 or greater, and most preferably 20 or greater. By the term, “steep positive hardness gradient” as used herein, it is meant surface to center Shore C hardness gradient of 20 or greater, more preferably 25 or greater, and most preferably 30 or greater. Methods for measuring the hardness of the inner core and surrounding layers and determining the hardness gradients are discussed in further detail below.

The center hardness of a core is obtained according to the following procedure. The core is gently pressed into a hemispherical holder having an internal diameter approximately slightly smaller than the diameter of the core, such that the core is held in place in the hemispherical portion of the holder while concurrently leaving the geometric central plane of the core exposed. The core is secured in the holder by friction, such that it will not move during the cutting and grinding steps, but the friction is not so excessive that distortion of the natural shape of the core would result. The core is secured such that the parting line of the core is roughly parallel to the top of the holder. The diameter of the core is measured 90 degrees to this orientation prior to securing. A measurement is also made from the bottom of the holder to the top of the core to provide a reference point for future calculations. A rough cut is made slightly above the exposed geometric center of the core using a band saw or other appropriate cutting tool, making sure that the core does not move in the holder during this step. The remainder of the core, still in the holder, is secured to the base plate of a surface grinding machine. The exposed ‘rough’ surface is ground to a smooth, flat surface, revealing the geometric center of the core, which can be verified by measuring the height from the bottom of the holder to the exposed surface of the core, making sure that exactly half of the original height of the core, as measured above, has been removed to within 0.004 inches. Leaving the core in the holder, the center of the core is found with a center square and carefully marked and the hardness is measured at the center mark according to ASTM D-2240. Additional hardness measurements at any distance from the center of the core can then be made by drawing a line radially outward from the center mark, and measuring the hardness at any given distance along the line, typically in 2 mm increments from the center. The hardness at a particular distance from the center should be measured along at least two, preferably four, radial arms located 180° apart, or 90° apart, respectively, and then averaged. All hardness measurements performed on a plane passing through the geometric center are performed while the core is still in the holder and without having disturbed its orientation, such that the test surface is constantly parallel to the bottom of the holder, and thus also parallel to the properly aligned foot of the durometer.

The outer surface hardness of a golf ball layer is measured on the actual outer surface of the layer and is obtained from the average of a number of measurements taken from opposing hemispheres, taking care to avoid making measurements on the parting line of the core or on surface defects, such as holes or protrusions. Hardness measurements are made pursuant to ASTM D-2240 “Indentation Hardness of Rubber and Plastic by Means of a Durometer.” Because of the curved surface, care must be taken to ensure that the golf ball or golf ball subassembly is centered under the durometer indentor before a surface hardness reading is obtained. A calibrated, digital durometer, capable of reading to 0.1 hardness units may be used for the hardness measurements. The digital durometer is attached to, and its foot made parallel to, the base of an automatic stand. The weight on the durometer and attack rate conform to ASTM D-2240. In certain embodiments, a point or plurality of points measured along the “positive” or “negative” gradients may be above or below a line fit through the gradient and its outermost and innermost hardness values. In an alternative preferred embodiment, the hardest point along a particular steep “positive” or “negative” gradient may be higher than the value at the innermost portion of the inner core (the geometric center) or outer core layer (the inner surface)—as long as the outermost point (i.e., the outer surface of the inner core) is greater than (for “positive”) or lower than (for “negative”) the innermost point (i.e., the geometric center of the inner core or the inner surface of the outer core layer), such that the “positive” and “negative” gradients remain intact.

As discussed above, the direction of the hardness gradient of a golf ball layer is defined by the difference in hardness measurements taken at the outer and inner surfaces of a particular layer. The center hardness of an inner core and hardness of the outer surface of an inner core in a single-core ball or outer core layer are readily determined according to the test procedures provided above. The outer surface of the inner core layer (or other optional intermediate core layers) in a dual-core ball are also readily determined according to the procedures given herein for measuring the outer surface hardness of a golf ball layer, if the measurement is made prior to surrounding the layer with an additional core layer. Once an additional core layer surrounds a layer of interest, the hardness of the inner and outer surfaces of any inner or intermediate layers can be difficult to determine. Therefore, for purposes of the present invention, when the hardness of the inner or outer surface of a core layer is needed after the inner layer has been surrounded with another core layer, the test procedure described above for measuring a point located 1 mm from an interface is used.

Also, it should be understood that there is a fundamental difference between “material hardness” and “hardness as measured directly on a golf ball.” For purposes of the present invention, material hardness is measured according to ASTM D2240 and generally involves measuring the hardness of a flat “slab” or “button” formed of the material. Surface hardness as measured directly on a golf ball (or other spherical surface) typically results in a different hardness value. The difference in “surface hardness” and “material hardness” values is due to several factors including, but not limited to, ball construction (that is, core type, number of cores and/or cover layers, and the like); ball (or sphere) diameter; and the material composition of adjacent layers, and thickness of the various layers. It also should be understood that the two measurement techniques are not linearly related and, therefore, one hardness value cannot easily be correlated to the other. Shore C hardness was measured according to the test methods D-2240.

Several different methods can be used to measure compression, including Atti compression, Riehle compression, load/deflection measurements at a variety of fixed loads and offsets, and effective modulus. See, e.g., Compression by Any Other Name, Science and Golf IV, Proceedings of the World Scientific Congress of Golf (Eric Thain ed., Routledge, 2002) (“J. Dalton”) The term compression, as used herein, refers to Atti or PGA compression and is measured using an Atti compression test device. A piston compresses a ball against a spring and the piston remains fixed while deflection of the spring is measured at 1.25 mm (0.05 inches). Where a core has a very low stiffness, the compression measurement will be zero at 1.25 mm. In order to measure the compression of a core using an Atti compression tester, the core must be shimmed to a diameter of 1.680 inches because these testers are designed to measure objects having that diameter. Atti compression units can be converted to Riehle (cores), Riehle (balls), 100 kg deflection, 130-10 kg deflection or effective modulus using the formulas set forth in J. Dalton. The approximate relationship that exists between Atti or PGA compression and Riehle compression can be expressed as: (Atti or PGA compression)=(160-Riehle Compression). Thus, a Riehle compression of 100 would be the same as an Atti compression of 60.

COR, as used herein, is determined by firing a golf ball or golf ball subassembly (e.g., a golf ball core) from an air cannon at two given velocities and calculating the COR at a velocity of 125 ft/s. Ball velocity is calculated as a ball approaches ballistic light screens which are located between the air cannon and a steel plate at a fixed distance. As the ball travels toward the steel plate, each light screen is activated, and the time at each light screen is measured. This provides an incoming transit time period inversely proportional to the ball's incoming velocity. The ball impacts the steel plate and rebounds through the light screens, which again measure the time period required to transit between the light screens. This provides an outgoing transit time period inversely proportional to the ball's outgoing velocity. COR is then calculated as the ratio of the outgoing transit time period to the incoming transit time period, COR=Vₒᵤₜ/Vᵢₙ=Tᵢₙ/Tₒᵤₜ. Preferably, a golf ball according to the present invention has a COR of at least about 0.78, more preferably, at least about 0.80.

The spin rate of a golf ball also remains an important golf ball characteristic. High spin rate allows skilled players more flexibility in stopping the ball on the green if they are able to control a high spin ball. On the other hand, recreational players often prefer a low spin ball since they do not have the ability to intentionally control the ball, and lower spin balls tend to drift less off the green.

Golf ball spin is dependent on variables including, for example, distribution of the density or specific gravity within a golf ball. For example, when the center has a higher density or specific gravity than the outer layers, a lower moment of inertia results which increases spin rate. Alternatively, when the density or specific gravity is concentrated in the outer regions of the golf ball, a higher moment of inertia results with a lower spin rate. The moment of inertia for a golf ball of the invention may be from about 0.410 oz-in² to about 0.470 oz-in². The moment of inertia for a one piece ball that is 1.62 ounces and 1.68 inches in diameter may be approximately 0.4572 oz-in², which is the baseline moment of inertia value.

Accordingly, by varying the materials and the density of the regions of each core or cover layer, different moments of inertia may be achieved for the golf ball of the present invention. In one embodiment, the resulting golf ball has a moment of inertia of from about to 0.440 to about 0.455 oz-in². In another embodiment, the golf balls of the present invention have a moment of inertia of from about 0.456 oz-in² to about 0.470 oz-in². In yet another embodiment, the golf ball has a moment of inertia of from about 0.450 oz-in^{t} toabout 0.460 oz-in².

Cerium oxide (CeO₂) particles having sizes in the range of the visible spectrum (about 370 nm-about 800 nm) reflect or scatter light and therefore provide opacity sufficient to cover the underlying golf ball core and create a white appearance to the human eye. Meanwhile unlike TiO₂, cerium oxide beneficially provides UV resistance without exhibiting an undesirable “photocatalytic effect”.

A golf ball cover comprising cerium oxide nanoparticles, having a particle size in the range of the wavelength of visible light, and being randomly incorporated into the cover, retains a whiter appearance over time as compared with a TiO₂-comprising cover as demonstrated in Table I below.

In this regard, the following experiment was performed to monitor ΔYI and Δb* for four inventive golf ball covers versus four comparative golf ball covers.

Eight golf ball covers, labeled I, IA, II, IIA, III, IIIA, IV, IVA, respectively, were formulated and then monitored and evaluated for comparative UV degradation, ΔYI and Δb* being measured after 5 days and then again after 8 days. All eight golf ball covers were prepared by combining in a static mixer prepolymer X from a holding tank A with the components from holding tank B, namely curing agent Y, white dispersion Z and either CeO₂ or TiO₂ as specified in Table I. For each of the eight cover formulations, an identical mixing temperature was chosen in the range from about 60° F. to about 180 ° F. (room temperature or under heat to speed up the reaction or reduce the viscosity of the mixture as desired). Cover I is identical to cover IA except that cover I comprises 1% CeO₂ and cover IA instead comprises 1% TiO₂ in addition to any TiO₂ contained in white dispersion Z. Cover II is identical to cover IIA except that cover II comprises 2% CeO₂ and cover IIA instead comprises 2% TiO₂ in addition to any TiO₂ contained in white dispersion Z. Cover III is identical to cover IIIA except that cover III comprises 3% CeO₂ and cover IIIA instead comprises 3% TiO₂ in addition to any TiO₂ contained in white dispersion Z. Cover IV is identical to cover IVA except that cover IV comprises 4% CeO₂ and cover IVA instead comprises 4% TiO₂ in addition to any TiO₂ contained in white dispersion Z.

The results are recorded in Table I below:

TABLE I

| | | Cover Formulation* | | | | | | | |
|---|---|---|---|---|---|---|---|---|---|
| | | I | IA | II | IIA | III | IIIA | IV | IVA |
| | | 1% CeO₂ | 1% TiO₂ | 2% CeO₂ | 2% TiO₂ | 3% CeO₂ | 3% TiO₂ | 4% CeO₂ | 4% TiO₂ |
| HCC 19584 | | 4.5% | 4.5% | 3.5% | 3.5% | 2.5% | 2.5% | 1.5% | 1.5% |
| Initial Yl | | −1.2 | −4.22 | 0.94 | −1.30 | 1.43 | 2.66 | 8.12 | 5.35 |
| Initial b | | −3.66 | −5.35 | −2.56 | −3.83 | 0.67 | −2.11 | 1.28 | −0.42 |
| Day 5 | ΔYl | 10.5 | 14.8 | 10.9 | 16.5 | 10.5 | 17.7 | 9.97 | 20.6 |
| | Δb | 6.25 | 8.65 | 6.60 | 9.87 | 6.34 | 12.5 | 6.00 | 12.8 |
| Day 8 | ΔYl | 12.2 | 17.7 | 12.1 | 19.4 | 12.6 | 21.5 | 11.7 | 25.5 |
| | Δb | 7.22 | 10.3 | 7.13 | 11.5 | 7.54 | 13.0 | 6.99 | 15.8 |

*The cover was formulated as follows: 1.0 equivalent of RAP 8.6 prepolymer; 0.95 equivalents of Ethacure 100LC; HCC 19584 white dispersion; and cerium oxide. RAP is a reaction product of HDI dimer with a silicone-amine adduct from Engineered Polymers. Ethacure 100LC is an amine curing agent from Albermarie. HCC 19584 is a white dispersion from The PolyOne Corporation. The cerium oxide is Polishing Opaline SM2 from Rhodia, having particle sizes in the range of from about 0.4μ-about 0.6μ (about 400 nm-about 600 nm).

As Table I above reveals, comparing covers I and IA, after 5 days, both ΔYI and Δb are favorably lower for cover composition I than cover composition IA—by 4.3 and 2.4, respectively. And after 8 days, ΔYI and Δb are both favorably lower for cover composition I than cover composition IA—by 5.5 and 3.08, respectively. Comparing covers II and IIA, after 5 days, ΔYI and Δb are also both favorably lower for cover composition II than cover composition IIA—by 5.6 and 3.27, respectively. And after 8 days, ΔYI and Δb are both favorably lower for cover composition II than cover composition IIA—by 7.3 and 4.37, respectively. Comparing covers III and IIIA, after 5 days, ΔYI and Δb are also both favorably lower for cover composition III than cover composition IIIA—by 7.2 and 6.16, respectively. And after 8 days, ΔYI and Δb are both favorably lower for cover composition III than cover composition IIIA—by 8.9 and 5.46, respectively. Comparing covers IV and IVA, after 5 days, ΔYI and Δb are also both favorably lower for cover composition IV than cover composition IVA—by 10.63 and 6.8, respectively. And after 8 days, ΔYI and Δb are both favorably lower for cover composition IV than cover composition IVA—by 13.8 and 8.81, respectively. Accordingly, the results above demonstrate that a golf ball comprising a cover incorporating CeO₂ having a particle size within the wavelength of visible light provides substantially reduced yellowing/UV degradation over a golf ball cover without CeO₂ and further, over a golf ball cover incorporating TiO₂ instead of CeO₂.

All of the golf ball covers in each of the examples above do comprise some TiO₂ in that the colorant of dispersion Z comprises a long chain triol and TiO₂. However, it is envisioned that a golf ball of the invention may alternatively have a cover incorporating CeO₂ and no TiO₂. This is because the reduced yellowing imparted to an inventive golf ball having a cover incorporating CeO₂ in at least the amounts and weight percents disclosed herein occurs independently of the presence or placement of TiO₂ in the golf ball cover.

Also, any other procedure known in the art for combining and mixing a prepolymer, curing agent and colorant may be used to form a golf ball cover of the invention in lieu of the method discussed above. Furthermore, the CeO₂ may be added into the formulation either along with the curative and a colorant from holding tank A or alternatively may be included as part of the prepolymer mix from holding tank A or even mixed into the static mixer from a completely separate holding tank C.

The compositions for golf ball components as disclosed herein may also be used in sporting equipment in general. Specifically, the compositions may be applied in various game balls, golf club shafts, golf club head inserts, golf shoe components, and the like. Additionally, the compositions for golf ball components as disclosed herein may also be used to reduce any UV degradation in golf balls/sporting equipment regardless of color.

All patents and patent applications cited in the foregoing text are expressly incorporated herein by reference in their entirety.

Unless otherwise expressly specified, all of the numerical ranges, amounts, values and percentages such as those for amounts of materials, and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

While it is apparent that the illustrative embodiments of the invention disclosed herein fulfill the preferred embodiments of the present invention, it is appreciated that numerous modifications and other embodiments may be devised by those skilled in the art. Examples of such modifications include reasonable variations of the numerical values and/or materials and/or components discussed above. Hence, the numerical values stated above and claimed below specifically include those values and the values that are approximate to those stated and claimed values. Therefore, it will be understood that the appended claims are intended to cover all such modifications and embodiments, which would come within the spirit and scope of the present invention.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. For example, the compositions of the present invention may be used in a variety of equipment. Such modifications are also intended to fall within the scope of the appended claims.

While any of the embodiments herein may have any known dimple number and pattern, a preferred number of dimples is 252 to 456, and more preferably is 328 to 392, although the golf ball of the invention may have any number of dimples or dimples configurations as presently known in the art. The dimples may comprise any width, depth, and edge angle and patterns which satisfy the relationships defined between cover layers as disclosed herein. The parting line configuration of said pattern may be either a straight line or a staggered wave parting line (SWPL). In one embodiment, the golf bal has 328, 330, 332, or 392 dimples, comprises 5 to 7 dimples sizes, and the parting line is a SWPL.

In any of these embodiments the single-layer core may be replaced with a two or more layer core wherein.

Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range.

Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

1. A method of making a golf ball comprising: providing a core; forming a cover comprising a thermoset or thermoplastic composition having an aromatic component by combining a prepolymer with a curing agent and a white pigment and then randomly dispersing from about 0.5 wt % to about 10 wt % of a composition for resisting UV degradation consisting of cerium oxide nanoparticles having a particle size of from about 370 nm to about 800 min into the cover composition, thereby forming a whiteness preserving cover that retains a white appearance when exposed to UV light; and molding the whiteness preserving cover about the core.

2. (canceled)

3. The method of claim 1, wherein the particle size is from about 400 nm to about 700 nm.

4. The method of claim 1, wherein particle size is from about 380 nm to about 500 nm.

5. The method of claim 1, wherein particle size is from about 500 nm to about 700 nm.

6. (canceled)

7. The method of claim 1, wherein the core comprises the cerium oxide nanoparticles in an amount of from about 1.0wt % to about 4.0wt %.

8. The method of claim 1, wherein the overall golf ball has a compression of from about 25 to about 110.

9. The method of claim 1, wherein the overall golf ball is at least about 0.780.

10. (canceled)

11. (canceled)

12. (canceled)

13. (canceled)

14. (canceled)

15. The method of claim 1, wherein the cover has a ΔYI from day 5 to day 8 of about 1.73 or less; and wherein the cover has a Δb* from day 5 to day 8 of about 0.99 or less.

16. The method of manufacturing a golf ball of claim 1, wherein the cover has a ΔYI from day 5 to day 8 of about 1.7; and wherein the cover has a Δb* from day 5 to day 8 of about 0.97.

17. The method of manufacturing a golf ball of claim 1, wherein the cover has a ΔYI from day 5 to day 8 of about 1.2; and wherein the cover has a Δb* from day 5 to day 8 of about 0.53.

18. A method of making a golf ball comprising: providing a core; forming a cover comprising a thermoset or thermoplastic composition having an aromatic component by combining a prepolymer with a curing agent and a white pigment and then randomly dispersing from about 0.5 wt % to about 10 wt % of a composition for resisting UV degradation consisting of cerium oxide nanoparticles having a particle size of from about 370 nm to about 800 nmin into the cover composition, thereby forming a whiteness preserving cover that retains a white appearance when exposed to UV light; and forming the whiteness preserving cover about the core, wherein the cover has a ΔYI from day 5 to day 8 of about 2.1 or less; and wherein the cover has a Δb* from day 5 to day 8 of about 1.2 or less.
